(19) United States
(12) Patent Application Publication
(10) Pub. No.: US 2005/0129165 A1
(43) Pub. Date: Jun. 16, 2005

(54) Nuclear power plant

(75) Inventors: Volker Pflug, Langenselbold (DE); Frank Domschat, Dietzenbach (DE)

Correspondence Address: LERNER AND GREENBERG, PA, P O BOX 2480, HOLLYWOOD, FL, 33022-2480, US

(73) Assignee: Framatome ANP GmbH

(21) Appl. No.: 10/949,986

(22) Filed: Sep. 24, 2004

Related U.S. Application Data
(63) Continuation of application No. PCT/EP03/03037, filed on Mar. 24, 2003.

(30) Foreign Application Priority Data
Mar. 27, 2002 (DE) 102 13 608.4

(51) Int. Cl. G21C 9/00

(52) U.S. Cl. 376/282

(57) ABSTRACT

A nuclear power plant, especially a boiling water reactor, has a containment unit in which the time and staff required for exchanging the fuel assemblies is considerably reduced. A sealing system, for example in the form of a sealing membrane, is stationarilly installed between the reactor pressure vessel and a core flooding pool of the nuclear power plant.

### CROSS-REFERENCE TO RELATED APPLICATION

This is a continuing application, under 35 U.S.C. § 120, of copending international application No. PCT/EP03/03037, filed Mar. 24, 2003, which designated the United States; this application also claims the priority, under 35 U.S.C. § 119, of German patent application No. 102 13 608.4, filed Mar. 27, 2002; the prior applications are herewith incorporated by reference in their entirety.

### BACKGROUND OF THE INVENTION

Field of the Invention

The invention relates to a nuclear power plant, in particular a boiling water reactor (BWR) with a reactor pressure vessel disposed in a containment unit.

Nuclear power plants of this type are known, for example, from German Patent DE 198 53 618 C1 or Published, Non-Prosecuted German Patent Application DE 195 38 009 A1. The interior of the containment unit of nuclear power plants of this type is divided into various subspaces by a plurality of inner walls and intermediate ceilings and has a charging cover that can be closed tightly. The reactor pressure vessel (RPV) is disposed in the central inner region and has a reactor core, in which the fuel assemblies are disposed, in its lower region and an opening, which can be tightly closed by a cover, at the top. The outside spaces of the containment serve as condensation chambers and flooding tanks for cooling the reactor pressure vessel and are connected to the latter via various lines.

To exchange the fuel assemblies, it is necessary for the reactor space to be flooded with demineralized water beyond the top edge of the reactor pressure vessel after the charging cover and the RPV cover have been removed. In the process, it must be ensured that there is a seal between the reactor pressure vessel and the flooding tank. For this purpose, each time fuel assemblies are changed, what is known as a flood compensator weighing a few tons is used in conventional nuclear power plants, and for the rest of the time the compensator has to be mounted outside the space which is to be flooded. The use of flood compensators of this type entails a number of drawbacks. For example, the changing of fuel assemblies is very time-consuming and requires a large staff, the flood compensator is expensive to produce, needs somewhere where it can be put down and also requires maintenance.

### SUMMARY OF THE INVENTION

It is accordingly an object of the invention to provide a nuclear power plant that overcomes the above-mentioned disadvantages of the prior art devices of this general type, in which fuel assemblies can be changed without high levels of outlay in terms of time and operating staff and therefore at low cost.

According to the invention, the object is achieved, for a nuclear power plant having a containment unit, a reactor space formed in the containment unit, a reactor pressure vessel disposed in the reactor space, and a flooding tank disposed in the containment unit. The reactor pressure vessel has an opening that can be closed off by a cover, by virtue of the fact that a fixedly installed seal is provided between the reactor pressure vessel and the flooding tank.

If there is a fixedly installed seal between the reactor pressure vessel and the flooding tank, there is no need for the expensive deployment and removal of a removable flood compensator, which requires large numbers of people, when changing fuel assemblies. Moreover, there is no need for there to be anywhere to put down such a compensator outside the flood space, and the outlay on maintenance, cleaning and regular inspections can be minimized. Moreover, the fixedly installed seal is less complex to produce and therefore less expensive than the conventional removable flood compensator, including the required assembly devices. The reduced operating staff costs when changing fuel assemblies also reduces the exposure of the staff to radiation. Furthermore, decontamination of the fixedly installed seal is also relatively easy to carry out.

In a particularly advantageous configuration, the seal between the reactor pressure vessel and the flooding tank is affected in the form of a fixedly installed sealing membrane. This is expediently connected on one side to the top edge of the reactor pressure vessel and on the other side to a wall of the reactor space surrounding it and contains a plurality of segments which are tightly connected to one another, for example by welding.

The seal may have at least one emptying line for discharging residual liquid following a change of fuel assemblies.

To achieve a high thermal barrier action, as is required for starting up and running down the nuclear power plant, within the seal, it is expedient for a thermally insulating device to be fitted to the underside of the seal.

A preferred material for the seal is an austenite, in particular the austenite given the DIN designation X6CrNiTi 1810.

Other features which are considered as characteristic for the invention are set forth in the appended claims.

Although the invention is illustrated and described herein as embodied in a nuclear power plant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic depiction of a containment unit in which there is fitted a reactor pressure vessel for a nuclear power plant according to the invention;

FIG. 2 is a partial sectional view of the reactor pressure vessel with a fixedly installed seal and taken along the line II-II shown in FIG. 1; and

FIG. 3 is an enlarged sectional view showing the seal of the nuclear power plant in accordance with detail III shown in FIG. 1.

### DESCRIPTION OF THE PREFERRED EMBODIMENTS

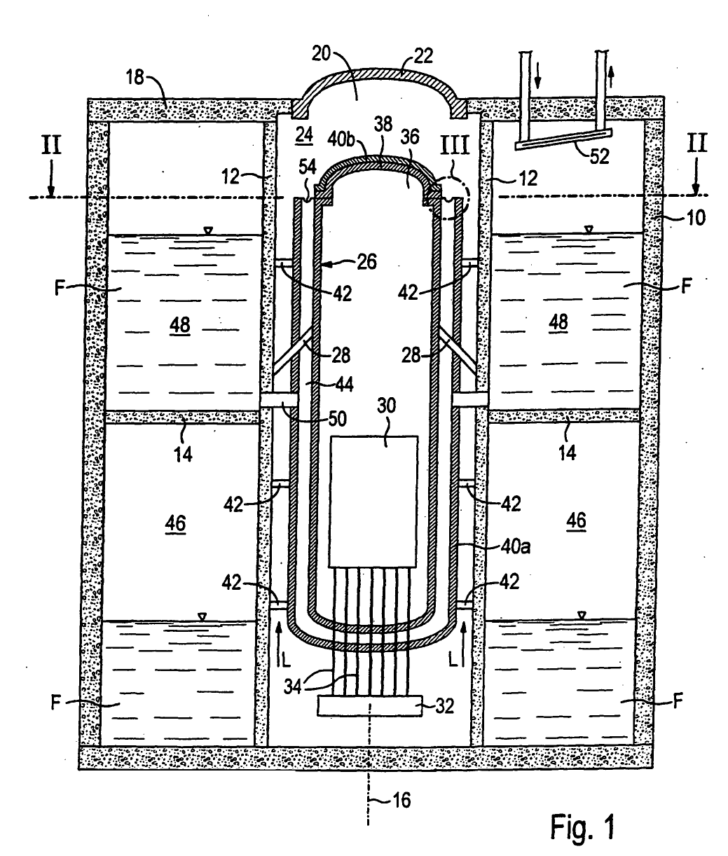

Referring now to the figures of the drawing in detail and first, particularly, to FIG. 1 thereof, there is shown a sketch of a containment unit 10 of a boiling water reactor plant (BWR plant). An interior of the containment unit 10 is divided into various subspaces by an inner cylinder 12 and an intermediate ceiling 14, with the structure of the containment unit 10 overall being substantially rotationally-symmetrical with respect to a longitudinal center axis 16. A central opening 20, which can be tightly closed off by a dome-shaped charging cover 22, is provided in a ceiling 18. All the walls and partitions of the containment unit 10 are preferably made from concrete.

A reactor pressure vessel (RPV) 26 is disposed in a central reactor space 24, surrounded by the inner cylinder 12, and the reactor pressure vessel 26 is supported on the inner cylinder 12 via a strut 28. The reactor pressure vessel 26, in its lower region, has a reactor core 30, in which the non-illustrated fuel assemblies are disposed. To increase the power, control rods are introduced into a reactor core 30 by a control rod drive 32, which is disposed at a lower end outside the reactor pressure vessel 26. Control rod guide tubes 34 extend from the control rod drive 32 through a wall of the reactor pressure vessel 26 into the reactor core 30.

At its upper end, the reactor pressure vessel 26 has an opening 36 which can be closed off tightly by a cover 38. The reactor pressure vessel 26 and its cover 38 are completely surrounded by an insulation canning 40a and 40b, respectively. The insulation canning 40a surrounding the reactor pressure vessel 26 is secured to the inner cylinder 12 by a large number of spacers 42 and is thereby spaced apart from the reactor pressure vessel 26 so as to form an intermediate space 44, so that the reactor pressure vessel 26 is externally accessible for maintenance purposes. The insulation cannings 40a, 40b serve to thermally insulate the reactor pressure vessel 26, so that the temperature in the intermediate space 44 is approximately 275° C. when the reactor is operating, and can therefore be kept in the region of the operating temperature inside the reactor pressure vessel 26. Outside the insulation canning 40a, 40b, the temperature is typically only approximately 50° C., for which purpose a cooling air stream L is provided from below between the insulation canning 40a and the inner cylinder 12.

Furthermore, the inner cylinder 12 in the interior of the containment unit 10, forms an annular outer space, which is divided into an upper outer space and a lower outer space by the intermediate ceiling 14. A lower annular outer space forms a condensation chamber 46, and the upper annular outer space forms a flooding tank 48, both of which contain a cooling liquid F, in particular cooling water. The flooding tank 48 and the condensation chamber 46 serve to cool the reactor pressure vessel 26 if a critical pressure is exceeded in the latter or in the reactor space 24. For this purpose, moreover, a plurality of cooling lines and non-illustrated cooling devices are present between the reactor pressure vessel 26 and the flooding tank 48 or the condensation chamber 46.

To cool the reactor pressure vessel 26, there is, inter alia, provision for external cooling or external flooding of the reactor pressure vessel 26, during which the cooling liquid F from the flooding tank 48 flows into the intermediate space 44, for example through a flooding line 50, so that the cooling liquid F comes into contact with the outer wall of the reactor pressure vessel 26. In the case of external flooding, the cooling liquid F is heated by the hot reactor pressure vessel 26, with the result that steam is formed in the intermediate space 44, and the steam can pass out of the intermediate space 44 into the upper region of the flooding tank 48 via a flow path that is not illustrated. In the upper region of the flooding tank 48 there is a condenser 52, at which the steam condenses, with the result that the pressure in the containment unit 10 can be reduced.

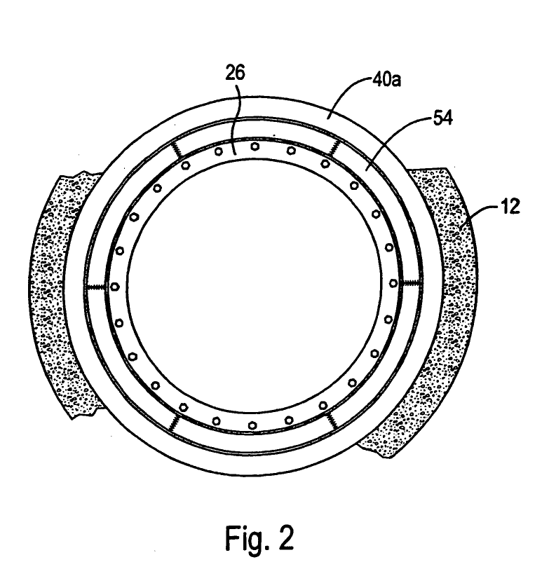

When changing fuel assemblies, it is necessary, inter alia, for the reactor space 24 to be flooded with demineralized water beyond the top edge of the reactor pressure vessel 26 after removal or opening of the charging cover 22 of the containment unit 10 and the cover 38 of the reactor pressure vessel 26. For this reason, it must be ensured that a seal is provided between the reactor pressure vessel 26 and the flooding tank 48 at least during this time. According to the invention, for this purpose a seal 54, as illustrated in FIG. 1, is provided between the reactor pressure vessel 26 and the wall of the reactor space 24, i.e. the inner cylinder 12 of the containment unit 10. As is illustrated in the sectional plan view shown in FIG. 2, the reactor space 24 above the reactor pressure vessel 26 is completely sealed off with respect to the wall 12 of the reactor space 24 by the seal 54 via the insulation canning 40a.

The seal 54 is fixedly installed, i.e. does not need to be fitted prior to a fuel assembly change or removed following a fuel assembly change. For this reason, less time and fewer operating staff are required for a fuel assembly change, which leads to considerable cost savings when operating the nuclear power plant. Moreover, there is no need for a separate space for the seal 54 to be provided outside the reactor space 24, as was the case with the conventional removable flood compensators. Furthermore, the permanently installed seal 54 makes it possible to ensure a continuously good functionality, since the sealing action is not dependent on the way in which the seal 54 is fitted prior to a fuel assembly change.

One criterion when configuring the fixedly installed seal 54 according to the invention is that the seal 54 should be able to absorb the thermal expansions that occur during operation, in particular when the reactor is being started up and shut down. In the exemplary embodiment shown in FIG. 1, the reactor pressure vessel 26 is accommodated in the upper region of the containment unit 10, so that in this case a lower axial thermal expansion needs to be taken into account compared to plants with reactor pressure vessels in the lower region of the containment unit 10, and consequently the solution proposed according to the invention of the fixedly installed seal 54 can be realized with an acceptable level of outlay. The required absorption of axial expansion which is to be taken into account here for the seal 54 is in the range of approximately 20 to 30 mm, whereas its radial expansion absorption is in the range from approximately 8 to 15 mm, with the temperature range during operation of the nuclear power plant extending from approximately room temperature (wall of the reactor space) up to approximately 290° C. (reactor pressure vessel). Moreover, the seal 54 must, of course, also be able to withstand the compressive load applied by the water column above it when the reactor space 24 is flooded.

Only the following work needs to be carried out for a fuel assembly change in a nuclear power plant as illustrated in FIG. 1. First, the cooling water F is released from the flooding tank 48, and then the charging cover 22 of the containment unit 10 is removed or opened. Then, the threaded bolts at the flange of the cover 38 of the reactor pressure vessel 26 are removed in the usual way. Next, the threaded holes for these threaded bolts have to be closed off by sealing plates, as is generally known, so that the demineralized water cannot come into contact with the ferritic threaded holes. Finally, before the cover 38 of the reactor pressure vessel 26 is opened, it is also necessary to seal off all the openings, such as manholes, ventilation flaps and the like, in the reactor space 24. The reactor space 24 can then be flooded with demineralized water for a fuel assembly change and the fuel assembly change can be carried out.

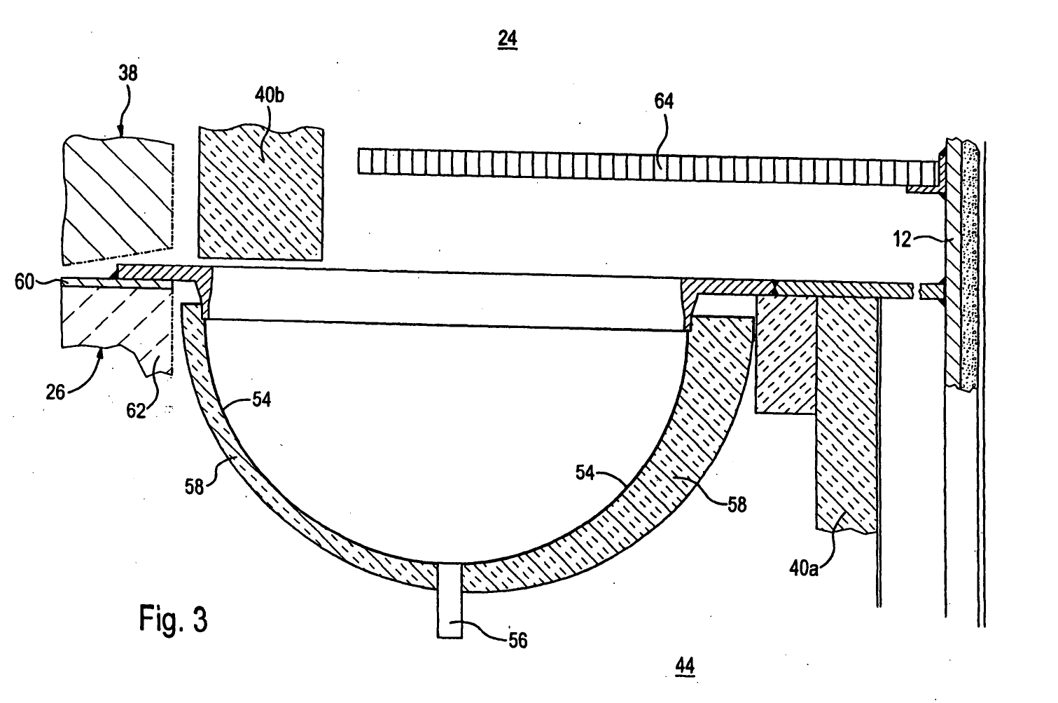

A preferred exemplary embodiment of a fixedly installed seal 54 according to the invention will now be explained in more detail with reference to FIG. 3, which corresponds to an enlarged illustration of detail III shown in FIG. 1.

The seal 54 illustrated in FIG. 3 is configured in the form of a sealing membrane 54. The sealing membrane 54 is configured in the form of a circular ring in order to surround the entire top edge of the reactor pressure vessel 26 and, by way of example, has the semicircular cross-sectional form shown in FIG. 3. The sealing membrane 54 may preferably be composed of, for example, six segments that are very carefully welded together on site during installation. The structure of the sealing membrane 54 containing a plurality of segments can be seen in the plan view presented in FIG. 2.

The sealing membrane 54 of the preferred exemplary embodiment is formed of an austenitic material, for example a material with the DIN designation X6CrNiTi 1810. The sealing membrane 54 is uniformly approximately 2 to 3 mm, preferably approximately 2.5 mm, thick, and the semicircular shape of the cross section has a radius of approximately 150 to 250 mm, preferably approximately 200 mm, so that a distance of approximately 300 to 500 mm, in the preferred case of approximately 400 mm, between the reactor pressure vessel 26 and the wall 12 of the reactor space 24 or the insulation canning 40a provided inside the reactor space 24 can be sealed off over the intermediate space 44.

To enable residual water which remains to be completely emptied out of the reactor space 24 again after the fuel assembly change has been completed, the sealing membrane 54 has, at its lowest point, at least one emptying line 56, which is of course tightly closed in the normal state.

To achieve the maximum possible thermal barrier action on the part of the sealing membrane 54, as is required in particular for starting up and shutting down the nuclear power plant, the sealing membrane 54 is provided with a thermal insulation 58 on its underside. Excessively rapid cooling of the sealing membrane 54 can be prevented by the thermal insulation 58. The thermal insulation 58 is formed, for example, of a chloride-free mineral wool and is approximately 15 to 60 mm thick; this thickness may increase from the inside outward over the arc of the sealing membrane 54, as illustrated in FIG. 3.

On its inner side, the sealing membrane 54 is welded to an austenitic plating 60 of a flange 62, which surrounds the opening 36 of the reactor pressure vessel 26, of the reactor pressure vessel 26. By contrast, the outer side of the sealing membrane 54 is welded to the wall 12 of the reactor space 24 or the insulation canning 40a disposed inside the reactor space, i.e. in other words is directly or indirectly joined to the wall 12 of the reactor space 24. The attachment points of the sealing membrane should satisfy not only the leaktightness requirement but also that of good heat conduction.

Furthermore, as illustrated in FIG. 3, an encircling grating 64 which can be walked upon and is intended to simplify maintenance of the sealing membrane 54, which is in any case only minor, is provided above the sealing membrane 54 in the reactor space 24. The distance between the sealing membrane 54 and the grating 64 is, for example, approximately 100 mm. Manholes for access to the grating 64 which can be walked upon must of course be sealed before the reactor space 24 is flooded in order for a fuel assembly change to be carried out.

Although the fixedly installed seal 54 according to the invention has been described above in the form of a sealing membrane, which forms the basis of a preferred embodiment, it is, of course, also possible to provide other designs of seals, provided that they ensure a suitable sealing action and are also able to withstand the thermal stresses which occur during operation of the nuclear power plant.

By way of example, it is also conceivable to provide a fixedly installed flooding space compensator in the reactor space. This would entail the same advantages in terms of time and operating staff when carrying out a fuel assembly change but would be more complex to produce and install.

1. A nuclear power plant, comprising:
a containment unit having a reactor space formed therein;
a reactor pressure vessel disposed in said reactor space and having an opening formed therein;
a cover closing off said opening of said reactor pressure vessel;
a flooding tank disposed in said containment unit; and
a fixedly installed seal disposed between said reactor pressure vessel and said flooding tank.

2. The nuclear power plant according to claim 1, wherein said seal is a fixedly installed sealing membrane disposed between said reactor pressure vessel and said flooding tank.

3. The nuclear power plant according to claim 2, wherein:
said containment unit has a wall defining part of said reactor space; and
said sealing membrane has a first side connected to a top edge of said reactor pressure vessel and a second side connected to said wall defining said reactor space.

4. The nuclear power plant according to claim 2, wherein said sealing membrane contains a plurality of segments which are tightly connected to one another.

5. The nuclear power plant according to claim 1, wherein said seal has at least one emptying line for discharging residual liquid.

6. The nuclear power plant according to claim 1, wherein said seal has an underside and a thermally insulating device disposed on said underside.

7. The nuclear power plant according to claim 1, wherein said seal is substantially formed from an austenitic material.

8. The nuclear power plant according to claim 1, further comprising a device which can be walked upon and disposed above said seal.
